(19) United States
(12) Patent Application Publication
(10) Pub. No.: US 2011/0314918 A1
(43) Pub. Date: Dec. 29, 2011

(54) PIPE INNER SURFACE INSPECTION APPARATUS

(75) Inventors: Seiichi Kawanami, Tokyo (JP); Masayoshi Nakai, Tokyo (JP); Masaya Takatsugu, Tokyo (JP); Masaharu Michihashi, Tokyo (JP)

(73) Assignee: MITSUBISHI HEAVY INDUSTRIES, LTD., Tokyo (JP)

(21) Appl. No.: 13/164,241

(22) Filed: Jun. 20, 2011

(30) Foreign Application Priority Data
Jun. 25, 2010 (JP) 2010-145043

(51) Int. Cl. G01N 29/04

(52) U.S. Cl. 73/623

(57) ABSTRACT

A pipe inner surface inspection apparatus that can accurately inspect the inlet portion of a pipe is provided. The pipe inner surface inspection apparatus provides a guide unit (13) that is inserted into a pipe head (5); stabilizers (15) (17) that are installed on the guide unit (13) with gaps therebetween in the axial direction and substantially align the axial center of the pipe head (5) and the axial center of the guide unit (13); a drive shaft (19) that moves in an axial direction and around an axial center and engages the guide unit (13); and an inspection portion (21), for inspecting the condition of the inner surface of a pipe head (5), is rotatably installed on pivot shafts extending in a direction normal to a plane perpendicular to the axial center of the pipe head (5) at the center position in an axial direction at a rearward position more separated in an axial direction than the portion of the guide unit (13) sandwiched between the stabilizers (15) (17) and the stabilizer (17) side end portion is positioned at the axial center side, and in an unloaded state, is energized so as to always move within a range in which the diameter of the outer peripheral side position of the stabilizer (17) side end portion is smaller than the inner diameter of the pipe head (5).

### CROSS-REFERENCE TO RELATED APPLICATIONS

This application is based on Japanese Patent Application No. 2010-145043, the contents of which are incorporated herein by reference.

### TECHNOLOGICAL FIELD

The present invention relates to a pipe inner surface inspection apparatus that is inserted into the interior of a pipe and that inspects the inner surface of the pipe or the condition of the interior of the pipe from the inner surface side.

### BACKGROUND ART

A pipe inner surface inspection apparatus, which is inserted into the interior of a pipe and inspects the inner surface of the pipe or the condition of the interior of the pipe from the inner surface side, is widely used when inspecting the installation portion of a pipe that has been inserted and arranged or inspecting the condition of the pipe inner surface while the pipe is arranged.

Japanese Unexamined Patent Application, First Publication No. H09-145687 discloses an example of such a pipe inner surface inspection apparatus.

This apparatus provides, in a probe head provided in the ultrasound defect detecting apparatus, a pair of stabilizers (centering members) that align the axial centers of a pipe and a probe head at the front and back of the ultrasonic defect detection apparatus, and a constant gap is maintained between the ultrasonic defect detection apparatus and the pipe inner surface by these stabilizers.

However, in the pipe inner surface inspection apparatus that has been disclosed in Japanese Unexamined Patent Application, First Publication No. H09-145687, because the ultrasonic defect detecting apparatus is disposed between the pair of stabilizers that are disposed such that a gap is provided in the axial direction, when an inlet portion of the pipe is inspected by the ultrasonic defect detection apparatus, a state occurs in which the back side stabilizer does not engage the pipe.

Thus, the orientation of the probe head is not stabilized, and because, for example, the axial center of the probe becomes angled with respect to the axial center of the pipe, there is a concern that accurate ultrasonic defect detection cannot be performed.

This has a significant affect when, for example, the inlet end surface of a pipe is a surface that is angled with respect to a plane perpendicular to the axial center. An example of a pipe having such a surface is a pipe head, which passes through a hemispherical portion of a nuclear reactor vessel, used in order to attach a control rod drive apparatus for driving a control rod in the hemispherical portion of a nuclear reactor vessel, and installed on the hemispherical portion by welding. That is, in the pipe head, the end surface is cut so as to conform to the inner surface shape of the hemispherical portion.

In consideration of such circumstances, it is an object of the present invention to provide a pipe inner surface inspection apparatus that can accurately inspect the inlet portion of a pipe.

### Problems to be Solved

The present invention uses the following devices in order to solve the problems described above.

Specifically, one aspect of the present invention is a pipe inner surface inspection apparatus that includes a guide unit that is inserted into the interior space of a pipe; a pair of centering members that are installed on the guide unit at intervals in an axial direction of the guide unit and that substantially align the respective axial center of the pipe and the axial center of the guide unit; drive shaft portions that are rod-shaped members extending in the axial direction and move in the axial direction and around an axial center, and engage the guide unit; and inspection members, for inspecting the inner surface or the condition of the interior of the pipe, that are installed at a rearward position separated more toward the axial direction than the portion sandwiched between the pair of centering members on the guide unit or the drive shaft members so as to be able to rotate on pivot shafts extending in a direction normal to a plane that is perpendicular to the axial center of the pipe at a center portion in the axial direction and the centering member side end portion is positioned at the axial center side, and, in an unloaded state, energized so as to always move outward within a range in which the diameter of the outer peripheral side position of the centering member side end portion is smaller than the inner radius of the pipe.

According to the present aspect, the drive shaft portion is moved to insert the guide unit into the interior of the pipe. When the guide unit is moved further into the interior of the pipe, the axial center of the pipe and the axial center of the guide unit are substantially aligned due to the pair of centering members. In this state, when the guide unit is moved, the inspection members, which are positioned at a more rearward position separated in an axial direction than the portion that is sandwiched between the pair of centering members, is positioned at the inlet portion of the pipe. Note that in the present specification, the term “rearward” denotes the back side when viewed in the direction in which the guide unit is inserted.

In this situation, because in an unloaded state the diameter of the outer peripheral side position of the centering member side end portions is set within a range that is smaller than the inner diameter of the pipe, the inspection members can be inserted into the interior of the pipe without being caught on the inlet end portion of the pipe.

Then, because the inspection members are positioned at the outer peripheral side sufficiently at the rearward side, the inspection members abut the inlet portion of the pipe at the rearward position. Because the inspection members are rotatably installed on pivot shafts extending in a direction normal to a plane that is perpendicular to an axial center of the pipe at the center position in an axial direction and is always energized so as to move outward, the inspection members rotate centered on the pivot shaft and more inward due to the force applied to the portion that abuts the pipe. Due to this action, in concert with always being energized so as to move outward, the outer peripheral side of the inspection members is aligned with the inner surface of the pipe, and thus, the inspection member can be positioned in a stable orientation.

In this manner, the inspection members can be placed in a stable orientation while the axial centers are aligned by the pair of centering members even at the inlet of the pipe, and thus, the inlet portion of the pipe can be accurately inspected.

Even if the inlet end portion of the pipe is a surface that is angled with respect to a plane that is perpendicular to the axial center, the inspection members operate similarly to the way they do at a position at which the pipe is present, and thus, even in the case in which the inlet end surface of a pipe is a surface that is angled in a flat surface shape or a curved surface shape with respect to a plane that is perpendicular to the axial center the inlet portion of the pipe, the inlet portion of the pipe can be accurately inspected.

Note that a plurality of inspection members maybe closely provided over the entire periphery in the peripheral direction and the entire surface inspection of the pipe may be carried out by moving the inspection members in the insertion direction by the movement of the guide unit or the drive shaft portion on which the inspection members are installed. Alternatively, one inspection member or a plurality of inspection members with gaps therebetween may be provided and the entire surface inspection of the pipe may be carried out by moving the inspection members in a peripheral direction or in the insertion direction by moving the guide unit or the drive shaft portion on which the inspection members are installed.

In the present aspect, the inspection members may be installed on this guide unit so as to move in the axial direction.

In this manner, inspection can be carried out within a range in which the inspection members move in an axial direction without moving the guide unit in the axial direction of the pipe. During inspection, because the guide unit does not move, causes of external disturbances that affect the operation of the inspection members can be reduced. Thereby, a more stable and accurate inspection can be carried out.

In the present aspect, the guide unit may be detachably engaged to the drive shaft members, and the inspection members may be installed on the drive shaft members.

In this manner, after the guide unit has been positioned at a predetermined position at which the inspection members are positioned within the inspection range, the drive shaft portion is detached from the guide unit, the drive shaft portion is moved in an axial direction and/or a peripheral direction of the pipe, and the inspection can thereby be carried out. After the inspection of a fixed range has been completed, the guide unit is engaged with the drive shaft member, the guide unit is moved to the next position, and the inspection is similarly carried out.

In this manner, during the inspection, because the guide unit is not moved, the causes of external disturbances that affect the operation of the inspection member can be reduced. Thereby, a more stable and accurate inspection can be carried out.

In this aspect, the inspection members may be an ultrasonic defect detecting member.

### Effects of the Invention

In the pipe inner surface inspection apparatus according to these aspects of the present invention, the inspection members are rotatably installed on pivot shafts extending in direction normal to a plane perpendicular to an axial center at a center position in an axial direction at a rearward position separated more in the axial direction than the portion sandwiched between a pair of centering members on the guide unit or the drive shaft portion, and the centering member side end portion is positioned at the axial center side. In addition, in an unloaded state, the inspection members are energized so as to always move outward within a range in which the diameter of the outer peripheral side position of the centering member side end portions is smaller than the inner diameter of the pipe. Thus, even if the inlet portion of the pipe or the inlet end surface of the pipe is a surface that is angled with respect to a plane that is perpendicular in an axial direction, the inspection can be correctly carried out.

### BRIEF EXPLANATION OF THE DRAWINGS

FIG. 1 is a cross-sectional view that shows the upper portion of a nuclear reactor vessel of a pressurized water reactor.

FIG. 2 is a block diagram that shows a schematic structure of the pipe inner surface inspection apparatus according to a first embodiment of the present invention.

FIG. 3 is a block diagram that shows the support structure of the inspection portion according to the first embodiment of the present invention.

FIG. 4 is a block diagram that shows a schematic structure of the pipe inner surface inspection apparatus according to a second embodiment of the present invention.

FIG. 5 is a side view that shows the support structure of the inspection portion according to the second embodiment of the present invention.

FIG. 6 is a front view that shows the support structure of the inspection portion according to the second embodiment of the present invention.

FIG. 7 is a block diagram that shows a schematic structure of the pipe inner surface inspection apparatus according to a third embodiment of the present invention.

### PREFERRED EMBODIMENTS

Below, embodiments of the present invention will be explained in detail with reference to the appended figures.

### First Embodiment

Below, a pipe inner surface inspection apparatus 1 according to a first embodiment of the present invention will be explained with reference to FIG. 1 to FIG. 3. The pipe inner surface inspection apparatus 1 according to the present embodiment inspects the welded portion of a pipe head 5 of a nuclear reactor vessel 3 in a pressurized water reactor.

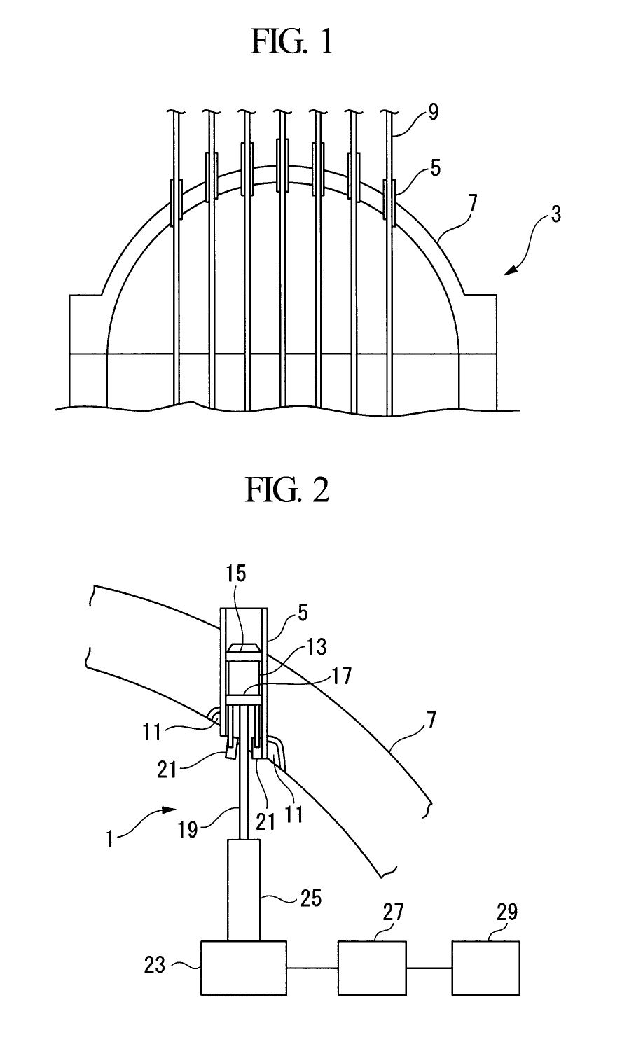

FIG. 1 is a cross-sectional view that shows the upper portion of the nuclear reactor vessel 3 of the pressurized water reactor. FIG. 2 is a block diagram that shows the schematic structure of a pipe inner surface inspection apparatus 1.

The upper portion of the nuclear reactor vessel 3 is formed by an upper hemispherical portion 7 that is substantially hemispherical shaped.

In the upper hemispherical portion 7, a plurality of control rod drive mechanisms 9, which are connected to the control rods inside the nuclear reactor and move the control rods in a vertical direction, are vertically provided in close proximity to each other. The pipe heads (pipes) 5 that guide the control rod drive mechanisms 9 are inserted into pipe head holes that are provided so as to pass through the upper hemispherical portion 7, and are attached by welding over the entire periphery at the inner surface side portion of the upper hemispherical portion 7.

When a defect occurs in the welded portion 11 that is formed between the inner surface portion of the upper hemispherical portion 7 and a pipe head 5, the defect develops and enlarges during the operation of the nuclear reactor, and there is a concern that the inside environment will leak outside of the nuclear reaction vessel 3.

Thus, inspecting for the presence of defects in the welded portions 11 is important.

As shown in FIG. 2, at the bottom end portion of the pipe head 5, there is a section that is cut in a form that conforms to the inner surface shape of the upper hemispherical portion. In this case, the bottom end surface (inlet end surface) of the pipe head 5 forms a surface that is angled in the shape of a curved surface with respect to a plane perpendicular to the axial center of the pipe head 5

The pipe inner surface inspection apparatus 1 mainly inspects defects in the welded portions 11 by using ultrasonic defect detection (UT).

The pipe inner surface inspecting apparatus 1 includes a substantially cylindrical guide unit 13 that performs guidance when inserted into the interior space of the pipe head 5; stabilizers (centering members) 15 are installed at the front (the side at which insertion is carried out is called the “front”, and the side that is subsequently entered is called the “back”) end portion of the guide unit 13, and substantially align the axial center of the pipe head 5 and the axial center of the guide unit 13; stabilizers (centering members) 17 are installed at the back end portion of the guide unit 13, and substantially align the axial center of the pipe head 5 and the axial center of the guide unit 13; a drive shaft (drive axis portion) 19 that is installed such that one end is attached to the guide unit 13 and extends in an axial direction; and a pair of sensor portions (inspection members) 21 that emit ultrasonic waves and receive the reflected wave.

The other end of the drive shaft 19 is installed so as to be attached to the output shaft 25 of the drive apparatus 23. The drive apparatus 23 moves the output shaft 25 in an axial direction, and at the same time, rotates the output shaft 25 around the axial center, and thereby, the drive shaft 19 and the guide unit 13 are moved in an axial direction and rotated around the axial center.

A defect detection portion 27, which generates ultrasonic waves in the sensor portion 21 and analyses the reflected waves that have been received by the sensor portion 21, and a control portion 29, which controls the operation of the drive apparatus 23 and the defect detection portion 27, are provided. The control portion is formed, for example, by a personal computer.

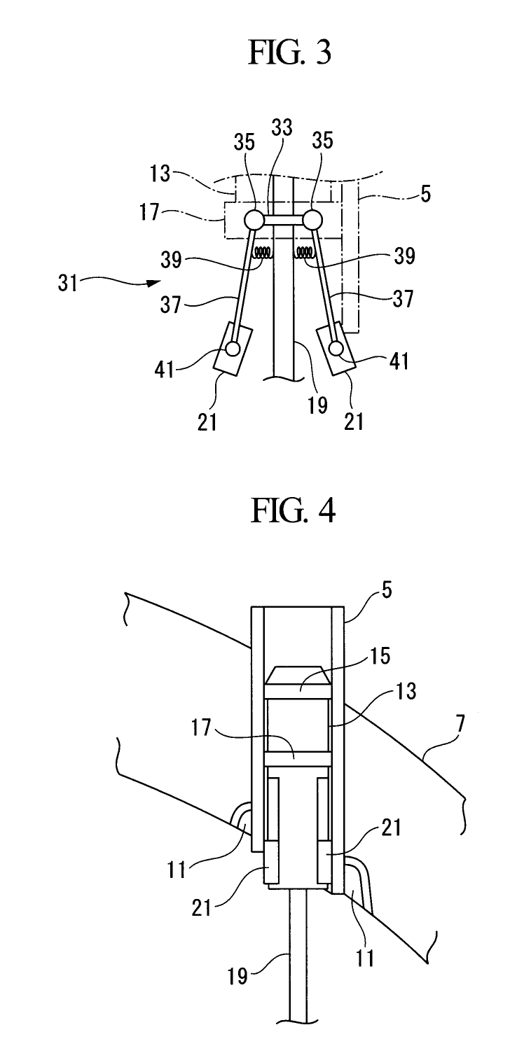

FIG. 3 is a block diagram that shows the support structure 31 of the sensor portion 21.

The support structure 31 includes a support beam 33 that is disposed below the guide unit 13 so as to be substantially perpendicular to the axial center; pivot shafts 35 that are rotatably installed at both end portions of the support beam 33 and extend in a direction normal to a circle perpendicular to the axial center of the guide unit 13; rod-shaped support rods 37 that are installed such that one end thereof is attached to the pivot shaft 35; compression springs 39 that are interposed between the support rods 37 and the drive shaft 19; and pivot shafts 41 that are installed so as to be attached to the other end portion of the support rods 37 and extend in a direction normal to a circle perpendicular to the axial center of the guide unit 13.

The pivot shafts 35 and 41 are parallel to each other. The sensor portions 21 are rotatably installed on the pivot shafts 41. Energizing members, such as a helical spring (not illustrated), are arranged between the sensor portions 21 and the pivot shafts 41. Due to this energizing member, the sensor portion 21 is energized such that the outer peripheral side position of the front side (the stabilizer 17 side) end portion is positioned more toward the drive shaft 19 side than the outer peripheral side position of the back side end portion. Thereby, in an unloaded state, as shown in FIG. 3, the front portion is angled as to be positioned inside. At this time, the installation position of the pivot shafts 41, the dimensions of the inspection members, and the energizing members are set such that the diameter of the outer peripheral side position of the front side end portion of the sensor portions 21 is smaller than the inner diameter of the pipe head 5, and in proximity to the drive shaft 41, the diameter of the outer peripheral side position of the sensor portions 21 at the front side position is larger than the inner diameter of the pipe head 5.

The strength of the compression spring 39 is set so that the sensor portion 21 is appropriately in contact with the pipe inner surface.

Note that a mechanism that maintains the inspecting member 21 at such an orientation is not limited to an energizing member such as a helical spring that is interposed between the sensor portion 21 and the pivot shaft 41, but any suitable mechanism that rotates the sensor portion 21 around the pivot shaft 41 can be used.

The operation of the pipe inner surface inspecting apparatus 1 having the above configuration will be explained.

Depending on the instruction from the control unit 29, the drive apparatus 23 is moved such that the guide unit 13 is positioned below that pipe head 5 that is the target of inspection. The drive apparatus 23 is moved depending on the instruction from the control portion 29, and the output shaft 25 is raised. Accompanying the raising of the output shaft 25, the drive shaft 19 rises, and the guide unit 13 is inserted into the interior of the pipe head 5.

When the output shaft 25 is raised further, the stabilizer 15 and then the stabilizer 17 are guided into the interior of the pipe head 5. The axial center of the pipe head 5 and the axial center of the guide unit 13 are substantially aligned due to the pair of stabilizers 15 and 17 that are provided with a gap therebetween in the axial direction.

In this state, when the output shaft 25 is further raised and the guide unit 13 is raised, the front side end portion of the sensor portion 21, having a diameter at the outer peripheral side position that is smaller than the inner diameter of the pipe head 5, is inserted into the pipe head 5.

In this manner, in an unloaded state, the sensor portion 21 has a diameter at the outer peripheral side position of the front side end portion that is smaller than the inner diameter of the pipe head 5, and thus, the sensor portion 21 can be inserted into the interior of the pipe head 5 without becoming caught on the inlet end portion of the pipe head 5.

When the sensor portion 21 is further raised, in proximity to the pivot shaft 41, having a diameter at the outer peripheral side position that is larger than the inner diameter of the pipe head 5, the sensor portion 21 abuts the pipe head 5, as shown in FIG. 3, further toward the front side position.

When the sensor portion 21 is further raised, a force that is downward from the pipe head 5 acts, and thus, the entire sensor portion 21 is moved into the interior accompanying the rotation around the drive shaft 41 due to this force.

Due to this action, as shown in FIG. 2, the outer peripheral side of the sensor portion 21 is oriented along the inner peripheral surface of the pipe head 5.

At this time, the sensor portion 21 is energized outward by the compression spring 39 via the support rod 37, and thus, due to the sensor portions 21 moving into the interior, the sensor portions 21 tend to press against the pipe head 5, and a stable orientation can be maintained.

In this state, the inspection is started by operating the defect detection portion 27. The guide unit 13, that is, the sensor portion 21, is raised a predetermined distance, the guide unit 13 is rotated around the axial center by a predetermined amount, then the sensor portion 21 is lowered by a predetermined distance, and the guide unit 13 is rotated around the axial center by a predetermined amount. Ultrasonic defect detection is carried out over the entire peripheral surface of the pipe 5 by repeating this process.

At this time, even if the inlet end surface of the pipe head 5, such as the one shown in FIG. 2, is a surface angled in a curved shape with respect to a plane that is perpendicular to the axial center, the operation described above is carried out at the position at which the pipe head 5 is present, and thus, the sensor portion 21 can maintain a stable orientation.

In this manner, the inspecting unit 21 is in a state in which the axial center of the pipe head 5 and the axial center of the guide unit 13 are substantially aligned and the stabilized orientation enables defect detection of the inlet portion of the pipe head 5 by using ultrasound, and thus, the inlet portion of the pipe head 5 can be appropriately inspected.

Note that in the present embodiment, two sensor portions 21 are provided and the entire peripheral surface is inspected by rotating these sensor portions 21 in a peripheral direction, but the number of the sensor portions 21 is not limited, and one or three or more may be used.

Alternatively, a plurality of sensor portions 21 may be arranged at appropriate intervals over the entire periphery, and the entire peripheral surface can be inspected simply by moving the guide unit 13 upward.

### Second Embodiment

Next, a tube inner surface inspection apparatus 1 according to a second embodiment of the present invention will be explained with reference to FIG. 4 to FIG. 6.

In the present embodiment, the support structure 51 that supports the sensor portions 21 and the structure of the guide unit 13 differ from those of the first embodiment, and thus, here, mainly the these differing portions will be explained, and redundant explanations of the portions that are identical to those of the first embodiment described above will be omitted.

Note that identical reference numerals are appended to members that are identical to those of the first embodiment.

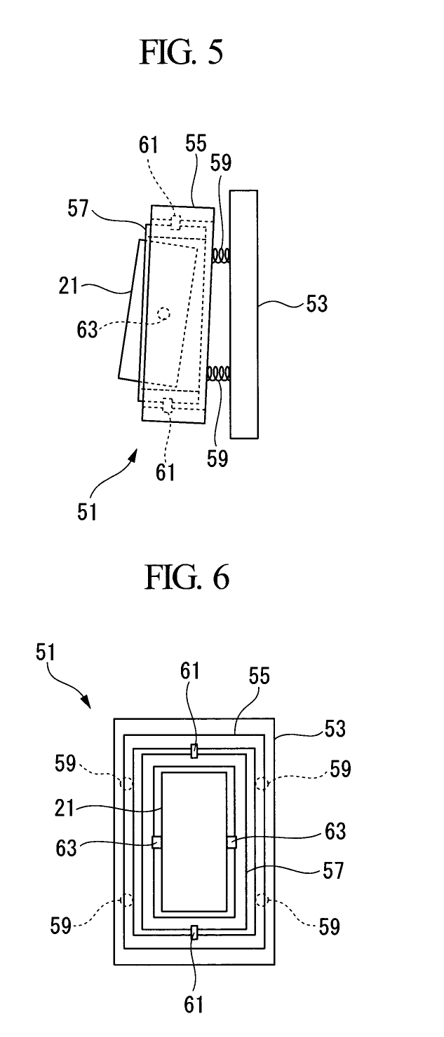

FIG. 4 is a block diagram that shows the schematic structure of the pipe inner surface inspecting apparatus 1 according to the present embodiment. FIG. 5 is a side view that shows the support structure 51 of the sensor portion 21. FIG. 6 is a front view that shows the support structure 51 of the sensor portion 21.

In the present embodiment, the guide unit 13 is structured so as to extend toward the back of the stabilizer 15. The sensor portions 21 are installed on this extended portion so as to be able to move in an axial direction.

A moving unit 53, an outer frame member 55, and an inner frame unit 57 are provided in the support structure 51 that supports the sensor portion 21.

The moving portion 53 is structured so as to have a rectangular solid shape, is attached to the guide unit 21 so as to be movable in the axial direction of the guide unit 13, and is moved in the axial direction of the guide unit 13 by a drive member (not illustrated). Any guide unit may be used that has a suitable form in which, for example, a rack is installed on the moving portion 53 and a pinion that is rotated by a motor are arranged on the guide unit 13 by meshing with a rack, or a portion of a belt that is periodically rotated is attached to the moving portion 53.

The outer frame member 55 is a rectangular tube, and is detachably installed on the moving portion 53 by compression springs 59 that are interposed between the outer frame member 55 and the moving portion 53 at two locations, upper and lower, on each of the long sides.

The strength of the compression springs 59 is set such that the sensor portion 21 is accurately brought into contact with the tube inner surface.

The shape of the outer frame member 55 is not limited to a rectangular shape, but may be a polygon, any shape formed by a curve such as a circle, or any shape partially formed by a curve.

The inner frame member 57 is a rectangular cylinder, and is disposed inside the outer frame member 55. The inner frame member 57 is connected to the outer frame member 55 by shafts 61 that extend in a longitudinal direction.

The shape of the inner frame member 57 is not limited to a rectangular shape, but may be a polygon, a shape that is formed by a curve such as a circle, or a shape that is partially formed by a curve.

The sensor portion 21 is disposed on the inside of the inner frame member 57 and is connected by a shaft (pivot shaft) 63 that extends in a peripheral direction, that is, the sensor portion 21 is rotatably installed on the shaft 63.

Thereby, the sensor portion 21 is supported so as to be able to rock in a peripheral direction and an axial direction with respect to the outer frame member 55. In other words, the sensor portion 21 is supported by the outer frame member 55 by a gimbal mechanism having two shafts.

An energizing member such as a coil spring (not illustrated) is arranged between the sensor portion 21 and the shafts 63. Due to this energizing member, the sensor portion 21 is energized such that the outer peripheral side position of the front side (stabilizer 17 side) end portion is positioned more toward the drive shaft 19 side than the outer peripheral side position of the back side end portion. Thereby, in an unloaded state, as shown in FIG. 5, the front portion is angled so as to be positioned in the interior. At this time, the installation position of the shafts 63, the dimensions of the inspection members, and the energizing member are set such that the diameter of the outer peripheral side position of the front side end portion of the sensor portions 21 is smaller than the inner diameter of the pipe head 5, and in proximity to the shaft 63, the diameter of the outer peripheral side position of the sensor portions 21 further toward the front side position is larger than the inner diameter of the pipe head 5.

Note that as a mechanism for maintaining the sensor portion 21 at such an orientation is not limited to an energizing member such as coil springs interposed between the sensor portion 21 and the shafts 63, but any suitable mechanism that can rotate the sensor portions 21 around the shafts 63 can be used.

The operation of the pipe inner surface inspection apparatus 1 structured as described above will be explained.

The portion of the operation in which the guide unit 13 is inserted into the interior of the pipe head 5, the axial center of the pipe head 5 and the axial center of the guide unit 13 are substantially aligned by the pair of stabilizers 15 and 17, and the sensor portion 21 is moved until being brought into contact with the pipe head 5, is identical to that of the first embodiment, and thus, here the redundant explanations are eliminated.

Note that the guide unit 13 is inserted while the sensor portion 21 is positioned farthest to the back (lower) side.

In this state, when the output shaft 25 is further raised and the guide unit 13 is raised, the front side end portion of the sensor portion 21, in which the diameter of the outer peripheral side position is smaller than the inner diameter of the pipe head 5, is inserted into the portion positioned farthest toward the back side of the pipe head 5.

In this manner, in the unloaded state, the diameter of the outer peripheral side position of the front side end portion of the inspection portion 21 is smaller than the inner diameter of the pipe head 5, and thus, the sensor portion 21 can be inserted into the interior of the pipe head 5 without becoming caught on the inlet end portion of the pipe head 5.

When the inspection portion 21 is further raised, in proximity to the shafts 63 having a diameter at the outer peripheral position that is larger than the inner diameter of the pipe head 5, the sensor portion 21 abuts the pipe head 5 at a position further toward the front.

When the sensor portion 21 is raised further, a force that is downward from the pipe head 5 acts, and thus, the sensor portion 21 rotates around the shaft 63 and moves entirely toward the inside due to this force. At this time, when the force acting in a peripheral direction becomes unbalanced, the inner frame member 57 rotates around the shaft 61 to cancel this unbalanced state.

Due this action, the outer peripheral side of the sensor portion 21 is oriented along the inner peripheral surface of the pipe head 5.

At this time, the sensor portions 21 are energized outward by the compression springs 59 via the outer frame member 55 and the inner frame member 57, and thus, the sensor portions 21 tend to be pressed against the pipe head 5 due to the sensor portion 21 being inward, and a stable orientation can be maintained.

In this state, the damage detection apparatus 27 is operated to start the inspection such that the guide unit 13 does not move in an axial direction. That is, the moving unit 53 moves upward to raise the sensor portion 21 a prescribed distance, the guide unit 13 rotates around the axial center a prescribed amount, and then the moving unit 53 is lowered by the prescribed distance, and the guide unit 13 rotates around the axial center a prescribed amount. By repeating this process, ultrasonic defect detection over the entire peripheral surface of the pipe head 5 is carried out.

At this time, even if the inlet end surface of the pipe head 5, such as the one shown in FIG. 4, is a surface that is angled in a curved shape with respect to a plane perpendicular to the axial center, the action described above is carried out at the position at which the pipe head 5 is present, and thus, the sensor portions 21 can be maintained in a stable orientation.

In this manner the sensor portions 21 can appropriately inspect the inlet portion of the pipe head 5 because the axial center of the pipe head 5 and the axial center of the guide unit 13 are substantially aligned and the stabilized position enables detecting damage in the inlet portion of the pipe head 5 by using ultrasonic waves.

In addition, while the sensor portions 21 are inspecting by moving in a vertical direction, the guide unit 13 cannot move in the axial direction of the pipe head 5, and thus, externally caused disturbances that affect the operation of the sensor portion 21 can be reduced. Thereby, an even more stable and correct inspection can be carried out.

Note that in the present embodiment, two sensor portions 21 are provided and the entire peripheral surface is inspected by rotating them in the peripheral direction, but the number of the sensor portions 21 is not limited to 2, and one or 3 or more may be provided.

In addition, a plurality of sensor portions 21 may be arranged with suitable gaps over the entire periphery, and the entire peripheral surface may be inspected simply by moving the guide unit 13 vertically.

### Third Embodiment

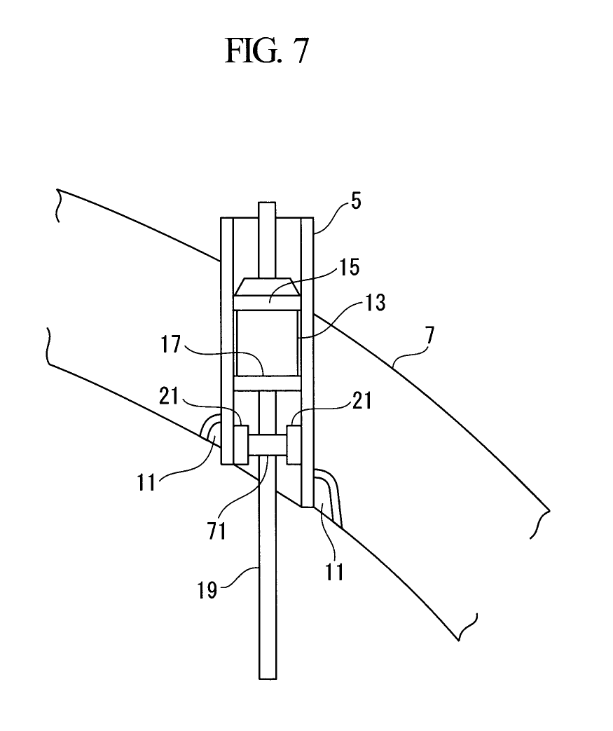

Next, the pipe inner surface inspection apparatus 1 according to a third embodiment of the present invention will be explained with reference to FIG. 7.

In the present embodiment, the structure of the support structure 71 that supports the sensor portions 21 and the guide unit 13 differs from those in the first embodiment, and thus, here mainly these differing portions will be explained, and the redundant explanation of the portions that are identical to those of the first embodiment described above will be omitted.

Note that identical reference numerals are appended to members that are identical to those in the first embodiment.

FIG. 7 is a block diagram that shows the schematic structure of the pipe inner surface inspecting apparatus 1 according to the present embodiment.

In the present embodiment, the guide unit 13 is detachably fastened to the drive shaft 19.

The sensor portion 21 is supported by the support structure 71 that has been installed so as not to move toward the drive shaft 19.

The support structure 71 supports the sensor portion 21 so as to allow rocking in a plane through which, as in the first embodiment, at least the axial center passes. Of course, similar to the second embodiment, support that allows rocking around an axis that extends in a peripheral direction may be added.

The support structure 71 is structured so as to support the inspection apparatus such that the outer peripheral side position of the front side end portion of the sensor portion 21 is positioned more toward the drive shaft 19 side than the outer peripheral side position of the back side end portion.

The support structure 71 supports the sensor portions 21 such that the front ends of the sensor portions 21 are angled so as to be positioned in the interior in an unloaded state, and the diameter of the outer peripheral side position of the front side end portion of the sensor portion 21 is smaller than the inner diameter of the pipe head 5 and the diameter of the outer peripheral side position of the sensor portions 21 at the substantially center position in an axial direction is larger than the inner diameter of the pipe head 5.

The operation of the pipe inner surface inspection apparatus 1 formed as above will be explained.

The sensor portion 21 is positioned at a position separated from the stabilizer 17, and the guide unit 13 engages the drive shaft 19. By moving the drive shaft 19, the guide unit 13 is inserted into the interior of the pipe head 5, and by being further extended, the axial center of the pipe head 5 and the axial center of the guide unit 13 are made to substantially align by the pair of stabilizers 15 and 17. In this state, when the output shaft 25 is further raised and the drive shaft 19 is raised along with the guide unit 13, the front side end portion of the sensor portions 21, in which the diameter of the outer peripheral side position is smaller than the inner diameter of the pipe head 5, are inserted into the portion positioned farthest toward the back side of the pipe head 5. At this time, the sensor portions 21 are positioned in a stable orientation at the inner surface of the pipe head 5, similar to the first embodiment and the second embodiment.

In this state, the guiding unit 13 is separated from the drive shaft 19 by preventing the guide unit 13 from moving. Then the defect detecting apparatus 27 is activated to start the inspection by the sensor portions 21. The drive shaft 19, that is, the sensor portions 21, is raised a predetermined distance, the drive shaft 19 is rotated around the axial center by a predetermined distance, and next, the drive shaft 19 is lowered a predetermined distance, and the drive shaft 19 is rotated around the axial center by a predetermined amount. The ultrasonic damage detection over the entire peripheral surface of the pipe head 5 is carried out by repeatedly carrying this procedure.

When the inspection of a certain range has completed, the guide unit 13 is engaged with the drive shaft 19, the guide shaft 13 is moved in an axial direction to the next position, and the inspection is similarly carried out.

At this time, even if the inlet end surface of the pipe head 5, such as the one shown in FIG. 7, is a surface that is angled in a curved shape with respect to a plane that is perpendicular to the axial center, the sensor portion 21 can be maintained in a stable orientation, similar to the first embodiment and the second embodiment.

In this manner, the sensor portion 21 can accurately inspect the inlet portion of the pipe head 5 because the axial center of the pipe head 5 and the axial center of the guide unit 13 are substantially aligned and defects in the inlet portion of the pipe head 5 can be detected by ultrasonic waves in a stable orientation.

In addition, while the sensor portions 21 are carrying out an inspection, because the guide unit 13 does not move, the causes of external disturbances that affect the operation of the sensor portion 21 can be reduced. Thereby, an even more stable and correct inspection can be carried out.

Note that the present invention is not limited by any of the embodiments that have been described above, and various modifications may be carried out within a range that does not depart from the spirit of the present invention.

For example, in the present embodiment, the tube inner surface inspection apparatus 1 is applied to the inner surface inspection of a pipe head 5, but naturally, this can be used in the inner surface inspection of a pipe other than the pipe head 5.

### BRIEF EXPLANATION OF THE REFERENCE NUMERALS

1 pipe inner surface inspection apparatus
5 pipe head
13 guide unit
15 stabilizer
17 stabilizer
19 drive shaft
21 sensor portion
41 pivot shaft
63 shaft

What is claimed is:

1. A pipe inner surface inspection apparatus comprising:
a guide unit that is inserted into the interior of a pipe head;
a pair of centering members that are installed on the guide unit with gaps in the axial direction and substantially align the axial center of the pipe head and the axial center of the guide unit;
a drive shaft that is a rod-shaped member extending in an axial direction and moves in an axial direction and around an axial center, and engages the guide unit; and
an inspection member, for inspecting the condition of the inner surface or the interior of a pipe, that is rotatably installed on pivot shafts extending in a direction normal to a plane perpendicular to the axial center of the pipe at the center position in an axial direction at a rearward position more separated in an axial direction than the portion sandwiched between the pair of centering members in the guide unit or the drive shaft portion and the centering member side end portion is positioned at the axial center side, and, in an unloaded state, are energized so as to always move outward within a range in which the diameter of the outer peripheral side position of the centering member side end portion is smaller than the inner diameter of the pipe.

2. The pipe inner surface inspection apparatus according to claim 1, wherein the inspection member is installed on the guide unit so as to move in the axial direction.

3. The pipe inner surface inspection apparatus according to claim 1, wherein the guide unit detachably engages to the drive shaft portion and the inspection members are installed on the drive shaft portion.

4. The pipe inner surface inspection apparatus according to claim 1, wherein the inspection member is ultrasonic defect detecting member.
